(19) United States
(12) Patent Application Publication
(10) Pub. No.: US 2009/0116460 A1
(43) Pub. Date: May 7, 2009

(54) APPARATUS AND METHOD FOR SCHEDULING FOR SUPPORTING QUALITY OF SERVICE OF DATA SERVICE IN MOBILE INTERNET SYSTEM

(75) Inventor: Jai-Dong KIM, Yongin-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/263,757

(22) Filed: Nov. 3, 2008

(30) Foreign Application Priority Data
Nov. 2, 2007 (KR) 10-2007-0111701

(51) Int. Cl. H04J 3/00

(52) U.S. Cl. 370/336

(57) ABSTRACT

An apparatus and method for setting a Quality of Service (QoS) level by a Portable Subscriber Station (PSS) in a mobile internet system are provided. The method includes determining a QoS request level serving as a QoS level required for transmitting a real-time packet if a packet to be transmitted is a real-time packet, transmitting the determined QoS request level to a Radio Access Station (RAS), receiving the QoS level determined corresponding to the QoS request level from the RAS and setting the QoS level to correspond to the received QoS level.

### PRIORITY

This application claims the benefit under 35 U.S.C. §119(a) of a Korean patent application filed in the Korean Industrial Property Office on Nov. 2, 2007 and assigned Serial No. 10-2007-0111701, the entire disclosure of which is hereby incorporated by reference.

### BACKGROUND OF THE INVENTION

1. Field of the Invention

The present invention relates to an apparatus and a method for providing a service in a mobile internet system. More particularly, the present invention relates to an apparatus and a method for scheduling for supporting a Quality of Service (QoS) level in a mobile internet system.

2. Description of the Related Art

The term “mobile internet system” refers to a service capable of accessing various information and contents through the wireless internet at a high data transmission speed using a mobile internet terminal anywhere and anytime regardless of the terminal's mobility. A representative example of the mobile internet system is a Mobile Worldwide Interoperability for Microwave Access (Mobile WIMAX) and a Wireless Broadband Internet (WIBRO) system which have been in domestic commercial use since 2006.

FIG. 1 is a diagram illustrating a network of a conventional mobile internet system.

Referring to FIG. 1, in the mobile internet system, Portable Subscriber Stations (PSSs) 101, 103, 105, and 107 are connected to an IP network 131 provided from a specific operator and access the IP network 131 by Radio Access Stations (RASs) 111, 113, 115, and 117 and Access Control Routers (ACRs) 121 and 123. The operator's IP network 131 is further connected to a Public IP network 141.

The PSSs 101, 103, and 105 may include any apparatus capable of accessing the mobile internet, such as a cellular phone, a Personal Digital Assistant (PDA), a notebook computer, and the like. The RASs 111, 113, 115, and 117 can wirelessly access the mobile internet, manage and control a wireless resource, and provide a corresponding PSS with a Quality of Service (QoS) level. The ACRs 121 and 123 perform a function of IP routing and mobility management. The function of the mobility management refers to providing each PSS with the IP based service when the PSS moves to another RAS during the communication. Further, the ACRs 121 and 123 provide an accounting server with the accounting service and control the mobility between the RASs 111 and 113 within one ACR, e.g. ACR 121. Further, the ACRs 121 and 123 manage and control the resource.

Through the above network, the mobile internet system provides real-time services which cannot tolerate a transmission delay, such as video or audio streaming, interactive games, or the like, or non real-time services which do permit a transmission delay, such as file transmission, a multimedia email, or the like. Because transmission delays are not permitted in the real-time services, necessary resources should be secured when the corresponding real time services are provided. However, when the non real-time services are provided, it is acceptable not to secure the necessary resources.

In the above described system, the addition or expansion of a service-providing field may cause a large increase in traffic. Therefore, there has been demand for substantially higher bandwidth in the mobile internet system as compared with the conventional wireless internet service. However, an additional or expanded application field may expand not only in a quantitative respect, but may also become substantially variable in a qualitatively respect, so that it is not possible to secure a high quality of service by only increasing the bandwidth. Accordingly, a technology for satisfying the demand of transmission reliability, real-time property, and the like, has been demanded together with the increase of the bandwidth. The technology referred to is a Quality of Service (QoS) level management technology.

A mobile internet system employs a packet scheme so that numerous subscribers, connected to the system at the same time, compete with each other for the use of resources. Therefore, the mobile internet system requires that the QoS level management chooses and executes a method of using a traffic resource for every service, contrary to the 3G wireless internet service. In this respect, the scheme of transmitting a packet from the mobile internet system to the PSS includes the following five scheduling models.

Prior to describing the scheduling models, some relevant terms will be generally defined.

The term ‘real-time’ (or ‘real-time service’) refers to the service, such as Voice over Internet Protocol (VoIP), which experiences trouble if a slight time delay occurs. The term ‘close real-time’ (or ‘close real-time service’) refers to the service, such as the streaming service, which permits a slight time delay. The term ‘non-real time’ (or ‘non-real time service’) refers to a service, such as email, which does not experience problems even if a relatively long time delay occurs. Hereinafter, the definition of the term ‘real-time’ (or ‘real-time service’) also includes that of the ‘close real-time’ (or ‘close real-time service’).

The scheduling models will be described with reference to the above term definitions.

First, a Best Efforts (BE) model provides, as its name implies, a best effort at transmitting the packet in the network, like the transmission of general data, such as emails, but cannot guarantee the reliable transmission of the packet.

Second, a Non Real-Time Polling Service (NRTPS) model requires high bandwidth, such as for a File Transfer Protocol (FTP), and supports a non real-time packet of a variable size.

Third, a Real-Time Polling Service (RTPS) model provides a real-time packet having a variable size that is generated for a variable time period, such as for a video telephone or an MPEG video function.

Fourth, an Unsolicited Grant Service (UGS) model provides a real-time packet having a fixed size that is generated for a fixed time period, such as for a VoIP function.

Fifth, an Extended Real-Time Polling Service (ERTPS) model provides traffic having aspects of both the RTPS and the UGS, i.e. provides the real-time packets having a variable size and generated for a fixed time period.

The connection between the PSS and the RAS according to the transmission scheme refers to Dynamic Service Addition (DSA). The DSA is classified into a BS-init DSA scheme, in which the transmission scheme is determined by the RAS and an MS-init DSA scheme, in which the transmission scheme is determined by the PSS.

The BS-init DSA scheme has a problem in that the RAS receiving the packet transmitted from the PSS cannot solely determine whether to provide QoS information of the packet. In order to solve this problem, an IP Multimedia Subsystem (IMS) is introduced in the core network. The IMS refers to a service of providing the mobile subscriber with the multimedia information using an Internet Protocol (IP) based packet network. The IMS has a separate function of receiving the QoS information according to the packet transmitted from the PSS. That is, if the IMS network receives the QoS information from the PSS, the IMS network transmits the received QoS information to the RAS, the RAS receives the QoS information from the IMS network and determines the transmission scheme depending on a type of the packet, so as to allocate the proper resource to the PSS.

The MS-init DSA scheme had been used before the IMS network was introduced. However, the MS-init DSA scheme did not have a means for allowing the terminal to determine a packet generated in a commercialized application, such as an instant messenger program or Skype, an internet telephone service using the messenger, etc. as a real-time packet. Therefore, the MS-init DSA scheme has a problem in that it cannot set an adequate transmission scheme for the real-time packet generated in the commercialized application so that the PSS cannot receive the adequate QoS information. Therefore, an apparatus and method are needed for providing a real-time packet service in a mobile internet system.

### SUMMARY OF THE INVENTION

An aspect of the present invention is to address at least the above-mentioned problems and/or disadvantages and to provide at least the advantages described below. Accordingly, an aspect of the present invention is to provide a method and an apparatus for providing a terminal with a real-time packet service in a mobile internet system.

Another aspect of the present invention is to provide a method and an apparatus for supporting a QoS level for providing a terminal with a real-time packet service in a mobile internet system.

Yet another aspect of the present invention is to provide a method and an apparatus for setting a QoS level for a real-time packet service by a terminal in a mobile internet system.

In accordance with an aspect of the present invention, a method for setting a Quality of Service (QoS) level by a Portable Subscriber Station (PSS) in a mobile internet system is provided. The method includes determining a QoS request level serving as a QoS level required for transmitting a real-time packet if a packet to be transmitted is a real-time packet, transmitting the determined QoS request level to a Radio Access Station (RAS), receiving the QoS level determined corresponding to the QoS request level from the RAS and setting the QoS level to correspond to the received QoS level.

In accordance with another aspect of the present invention, an apparatus for supporting a Quality of Service (QoS) level by a Portable Subscriber Station (PSS) in a mobile internet system is provided. The system includes a QoS setting unit for determining a QoS request level serving as a QoS level requested for transmitting a real-time packet if a packet to be transmitted is a real-time packet, a transmitting/receiving unit for transmitting the determined QoS request level to a Radio Access Station (RAS) and a connection setting unit for setting the QoS level to correspond to the received QoS level.

In accordance with still another aspect of the present invention, a method for supporting a Quality of Service (QoS) level by a Radio Access Station (RAS) in a mobile internet system is provided. The method includes transmitting, if a QoS request level to be used for transmitting a real-time packet is received from a transmitting Portable Subscriber Station (PSS), a QoS level determined in correspondence with the QoS request level to the transmitting PSS and transmitting, if the real-time packet in which a packet transmission scheme selected in correspondence with the QoS level is received from the transmitting PSS, the real-time packet to a receiving PSS.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a diagram illustrating a network of a conventional mobile internet system;

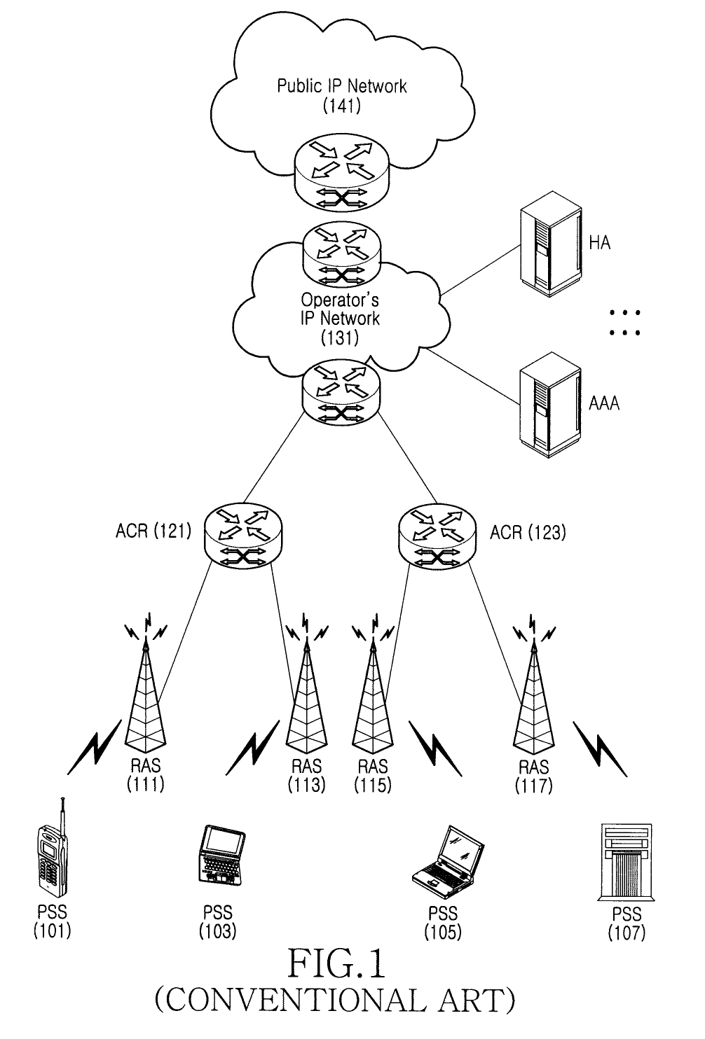

FIG. 2 is a flowchart illustrating a method for supporting a QoS in a mobile internet system according to an exemplary embodiment of the present invention;

FIG. 3 is a diagram illustrating an IP packet according to an exemplary embodiment of the present invention;

FIG. 4 is a diagram illustrating a scheduling apparatus for supporting a QoS in a mobile internet system according to an exemplary embodiment of the present invention; and

FIG. 5 is a flowchart illustrating transmission/reception between an RAS and a PSS in a mobile internet system according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constrictions are omitted for clarity and conciseness. In the following description, various specific definitions are provided only to help in a general understanding of the present invention, and it should be apparent to those skilled in the art that the present invention can be implemented without such definitions.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention parse a packet generated by an application of a Portable Subscriber Station (PSS) and determine a transmission scheme depending on the packet.

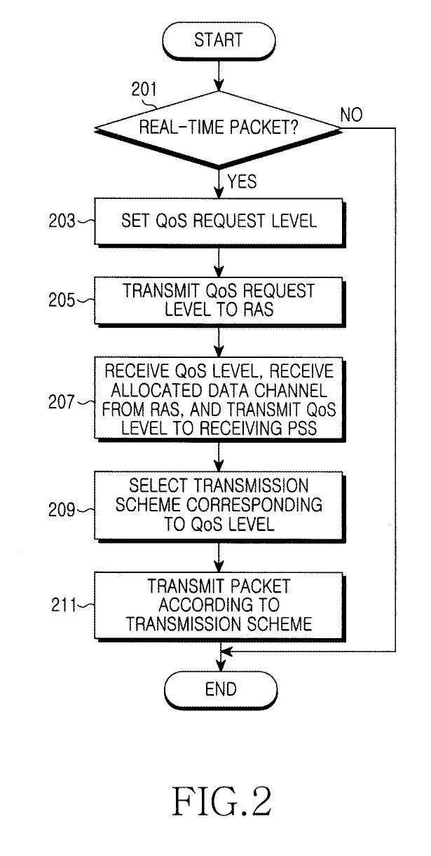

FIG. 2 is a flowchart illustrating a method for scheduling in a PSS for supporting a QoS level in a mobile internet system according to an exemplary embodiment of the present invention.

Referring to FIG. 2, the PSS, which is executing an application that is generating packets for transmission, determines if a packet generated by the application is a real-time packet in step 201. An exemplary scheme of determining if the packet generated by the application is a real-time packet includes a determination based on a protocol used by the packet. That is, if the packet to be transmitted uses a protocol associated with transmission/reception of a real-time packet, the packet is determined to be a real-time packet. Hereinafter, a User Datagram Protocol (UDP) and a Realtime Transport Protocol (RTP) are each defined as a real-time protocol. Of course, the real-time protocol may include not only the UDP and RTP, but also any-named protocol that transmits/receives packets in real-time. Further, the packet transmitted using the real-time protocol is defined as a ‘real-time protocol packet’.

If it is determined that the packet is a real-time packet in step 201, the PSS sets a QoS request level required for transmitting the corresponding real-time packet in step 203. In setting the QoS request level, the PSS statistically parses a Destination IP (DST IP) address, a DST Port, and a Media Access Control Packet Data Unit (MAC PDU) size of the packet to be transmitted so as to set a maximum sustained rate and a minimum reserved rate of the corresponding application. As an analogy, the setting of the QoS request level is like an analysis by a train company that must determine the number of trains for getting passengers to a destination. The train company analyses a movement distance (i.e. DST IP address) and the number of passengers (i.e. MAC PDU size) to determine the number of trains (i.e. the maximum sustained rate and the minimum reserved rate) that must run without making the passengers wait while making the most profit for the train company.

In step 205, the PSS transmits the QoS request level set in step 203 to an RAS. A channel through which the QoS request level is transmitted need not be a data channel through which the packet generated by the application is transmitted, but may be a channel used for transmitting/receiving a separate control message between the PSS and the RAS. In an exemplary embodiment of the present invention, the control channel through which the QoS request level is transmitted is referred to as a QoS set channel. Of course, other control messages for setting communications between the PSS and the RAS in addition to the QoS request level can be transmitted/received through the QoS set channel. At this time, because of the competition between a plurality of PSSs for use of the RAS controlled channel, the RAS determines the QoS level to be applied to the real-time packet of the corresponding PSS considering not only the requested QoS level, but also the efficiency of the general channel and allocates a corresponding data channel to the corresponding PSS. Therefore, the allocated data channel may not completely correspond to the requested QoS level. Also, the QoS level can be transmitted to the PSS through the QoS set channel or the allocated QoS data channel.

If the PSS receives the allocated data channel and the QoS level from the RAS in step 207, the PSS directly transmits the QoS level to a receiving PSS. The receiving PSS is a terminal with which the corresponding PSS will communicate using the application that generates the real-time packets. Transmitting the QoS level to the receiving PSS is for the purpose of notifying the receiving PSS of the QoS level determined between the corresponding PSS and RAS. If the receiving PSS is a mobile internet terminal, e.g. a terminal subscribing to a Wimax or Wibro service, the receiving PSS prepares to receive the real-time packet having a defined formation according to the determined QoS level. If the receiving PSS is not a mobile internet terminal, the determined QoS level can be ignored because no problem will occur in transmitting/receiving the real-time packet even if there is no QoS control.

In step 209, the PSS selects a transmission scheme for transmitting the real-time packet according to the QoS level. That is, the PSS selects any one of RTPS, UGS, ERTPS and the like used to transmit the real-time packet for satisfying the characteristic of the real-time packet to be transmitted and the determined QoS level. In step 211, the PSS transmits the real-time packet to the RAS via the data channel using the selected transmission scheme. After the transmission of step 211, the process is ended. Also, referring again to step 201, if it is determined that the packet is not a real-time packet, the process of FIG. 2 is ended.

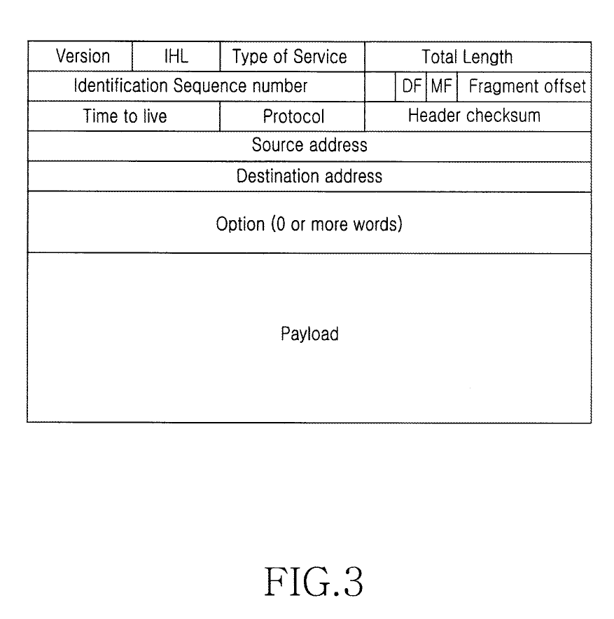

FIG. 3 is a diagram illustrating an IP packet according to an exemplary embodiment of the present invention.

Referring to FIG. 3, a protocol field represents the type of upper protocol included in the data. Therefore, the PSS recognizes a real-time protocol packet through the protocol field of the corresponding packet.

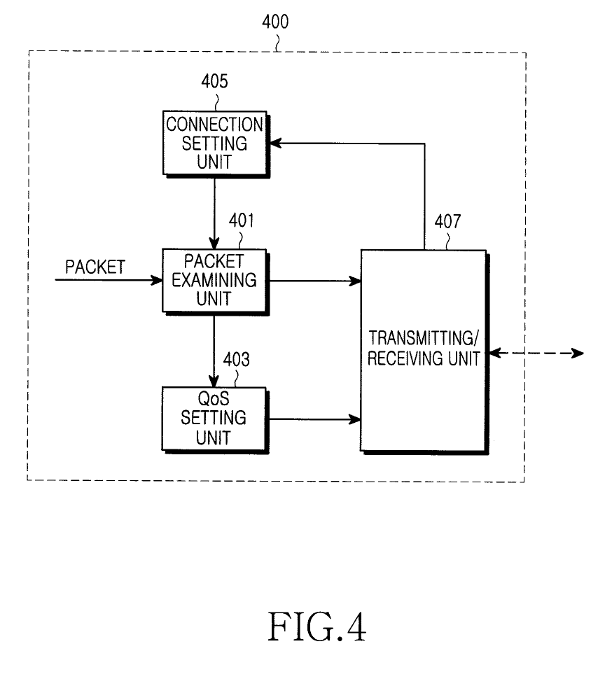

FIG. 4 is a diagram illustrating a scheduling apparatus for supporting a QoS in a mobile internet system according to an exemplary embodiment of the present invention.

Referring to FIG. 4, the scheduling apparatus 400 includes a packet examining unit 401, a QoS setting unit 403, a connection setting unit 405, and a transmitting/receiving unit 407. The packet examining unit 401 receives a packet generated by the application being executed by the PSS and determines if the received packet is a real-time packet. If the received packet is determined to be a non real-time packet, the packet examining unit 401 transmits the non real-time packet to the transmitting/receiving unit 407. The transmitting/receiving unit 407 transmits the non real-time packet to the RAS (not shown). In the alternative, if the received packet is determined to be a real-time packet, the packet examining unit 401 transmits the real-time packet to the QoS setting unit 403. The QoS setting unit 403 statistically parses the real-time packet and sets the QoS request level so as to transmit the set QoS request level to the transmitting/receiving unit 407. A method for setting the QoS request level is substantially identical to step 203 of FIG. 2 so that its detailed description will be omitted. The transmitting/receiving unit 407 transmits the QoS request level to the RAS, receives the QoS level corresponding to the QoS request from the RAS, and transfers the received QoS level to the connection setting unit 405. The connection setting unit 405 selects the transmission scheme for the real-time packet according to the received the QoS level and transfers information on the selected transmission scheme to the packet examining unit 401. Then, the packet examining unit 401 transfers the real-time packet and the information on the transmission scheme to the transmitting/receiving unit 407. The transmitting/receiving unit 407 transmits the real-time packet to the RAS according to the set transmission scheme.

Further, the transmitting/receiving unit 407 transmits the QoS level received from the RAS to the receiving PSS (not shown), which is for the purpose of setting for receiving the real-time packets according to the received QoS level, if the receiving PSS is a mobile internet terminal. However, if the receiving PSS is not a mobile internet terminal, the receiving PSS does not require setting of the QoS, and the QoS level may be ignored in that regard.

Hereinafter, a state of transmission/reception of a transmitting PSS with an RAS and a receiving PSS will be described.

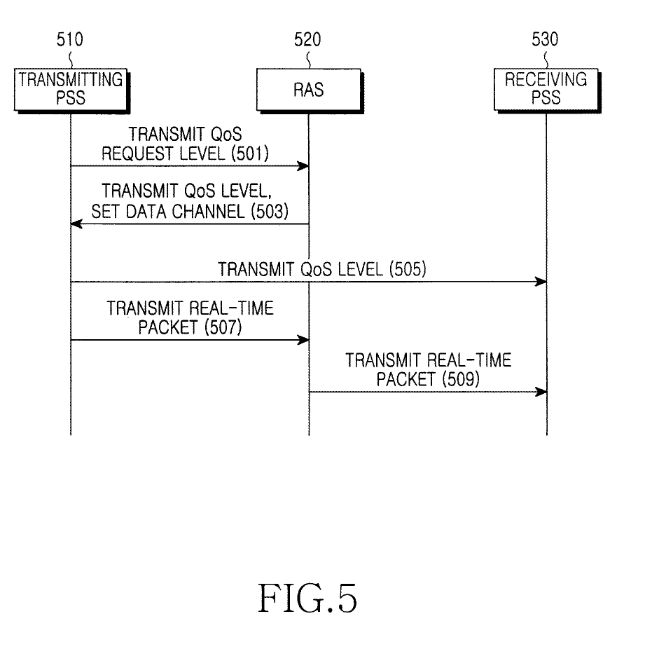

FIG. 5 is a flowchart illustrating transmission/reception between an RAS and a PSS in a mobile internet system according to an exemplary embodiment of the present invention.

Referring to FIG. 5, a transmitting PSS 510 transmits a QoS request level, for example a QoS request level as set in step 203 of FIG. 2, to an RAS 520 in step 501. The RAS 520 transmits the QoS level corresponding to the QoS request level to the transmitting PSS 510 and authorizes the setting of the data channel of the transmitting PSS 510 in step 503. The transmitting PSS 510 transmits the QoS level to a receiving PSS 530 in step 505. The receiving PSS 530 is a mobile internet terminal so that the receiving PSS 530 prepares for receiving the real-time packets according to the QoS level received from the transmitting PSS 510. That is, the receiving PSS 530 performs steps substantially similar to steps 501 and 503 performed by the transmitting PSS 510 and the RAS 520. If the receiving PSS 530 is included in a cell coverage area that is different from the cell coverage area of the RAS 520, then the receiving PSS 530 performs steps similar to steps 501 and 503 with respect to the different RAS (not shown) in whose cell coverage area the receiving PSS 530 is located. If the receiving PSS is not a mobile Internet terminal, it is not necessary to set the QoS and therefore step 505 may be omitted or at least the QoS level can be ignored. The transmitting PSS 510 transmits the real-time packets to the RAS 520 in step 507 and the RAS 520 transmits the real-time packets received in step 507 to the receiving PSS 530 in step 509.

Therefore, exemplary embodiments of the present invention can provide the PSS with the real-time packet service in the mobile internet system and select the transmission scheme based on whether the packet transmitted by the PSS is a real-time packet to support the QoS level depending on the type of the real-time packet. Further, if the receiving PSS is a mobile internet terminal, the receiving PSS can set the QoS level according to the transmission scheme selected by the transmitting PSS in order to promptly prepare for the transmission/reception of the packet so as to improve the performance of the entire system.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for setting a Quality of Service (QoS) level by a Portable Subscriber Station (PSS) in a mobile internet system, the method comprising:
determining a QoS request level serving as a QoS level required for transmitting a real-time packet if a packet to be transmitted is the real-time packet;
transmitting the determined QoS request level to a Radio Access Station (RAS);
receiving the QoS level determined corresponding to the QoS request level from the RAS; and
setting the QoS level to correspond to the received QoS level.

2. The method of claim 1, wherein the step of determining the QoS request level comprises:
statistically parsing packet information including at least one of a Destination Internet Protocol (DST IP) address and a size of the real-time packet; and
setting a maximum sustained rate and a minimum reserved rate to be used for transmitting the real-time packet.

3. The method of claim 1, further comprising selecting a packet transmission scheme to be used for transmitting the real-time packet corresponding to the received QoS level.

4. The method of claim 1, further comprising transmitting information on the set QoS level to a PSS scheduled to receive the real-time data.

5. An apparatus for supporting a Quality of Service (QoS) level by a Portable Subscriber Station (PSS) in a mobile internet system, the apparatus comprising:
a QoS setting unit for determining a QoS request level serving as a QoS level requested for transmitting a real-time packet if a packet to be transmitted is the real-time packet;
a transmitting/receiving unit for transmitting the determined QoS request level to a Radio Access Station (RAS); and
a connection setting unit for setting the QoS level to correspond to the received QoS level.

6. The apparatus of claim 5, wherein the QoS setting unit statistically parses packet information including at least one of a Destination Internet Protocol (DST IP) address and a size of the real-time packet and sets a maximum sustained rate and a minimum reserved rate to be used for transmitting the real-time packet.

7. The apparatus of claim 5, wherein the connection setting unit selects a packet transmission scheme to be used for transmitting the real-time packet corresponding to the received QoS level.

8. The apparatus of claim 5, wherein the transmitting/receiving unit transmits information on the set QoS level to a PSS scheduled to receive the real-time data.

9. A method for supporting a Quality of Service (QoS) level by a Radio Access Station (RAS) in a mobile internet system, the method comprising:
transmitting, if a QoS request level to be used for transmitting a real-time packet is received from a transmitting Portable Subscriber Station (PSS), a QoS level determined in correspondence with the QoS request level to the transmitting PSS; and
transmitting, if the real-time packet in which a packet transmission scheme selected in correspondence with the QoS level is received from the transmitting PSS, the real-time packet to a receiving PSS.

10. The method of claim 9, further comprising transmitting the determined QoS level to the receiving PSS prior to receiving the real-time packet from the transmitting PSS.
